(19) United States
(12) Patent Application Publication
(10) Pub. No.: US 2008/0273016 A1
(43) Pub. Date: Nov. 6, 2008

(54) INTEGRATED TOUCH-SCREEN CONTROL PANEL FOR A WASHING APPLIANCE AND METHOD FOR PRODUCING THE SAME

(75) Inventor: John Helgesen, Rock Hill, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/111,337

(22) Filed: Apr. 29, 2008

Related U.S. Application Data
(60) Provisional application No. 60/916,135, filed on May 4, 2007.

(51) Int. Cl. G06F 3/041; B29C 69/00

(52) U.S. Cl. 345/173; 264/2.7

(57) ABSTRACT

Various embodiments of the present invention provide a touch-screen user interface system for a dishwasher. In one aspect, the system includes an illuminated display operably engaged with a door of the dishwasher having a plurality of touch-responsive surfaces associated therewith, and a cover operably engaged with the illuminated display so as to enclose the illuminated display in a substantially fluid-tight arrangement and such that each of the plurality of touch-responsive surfaces are visible and accessible to a user of the dishwasher via the cover. Various embodiments of the present invention also provide a method of manufacturing an integrally-formed lens member and console member for such a touch-screen user interface system.

### CROSS REFERENCE TO A RELATED APPLICATION

The present application claims the benefit of U.S. Provisional Patent Application No. 60/916,135 filed on May 4, 2007, which application is incorporated herein by reference in its entirety.

### BACKGROUND OF THE INVENTION

1. Field of the Invention

Various embodiments of the present invention are directed to washing appliances and, more particularly, to an integrated touch-screen control panel for a washing appliance, such as a dishwasher, and methods associated therewith.

2. Description of Related Art

Washing appliances, such as dishwashers, may include a control panel operably engaged with an upper portion of a front door member such that a user may easily access the control panel. Conventional dishwashers may particularly include control panels having mechanical switches and/or flexible membrane switches that may be sealed from the relatively wet environment around the dishwasher.

While many modem electronic devices and electrical appliances utilize “touch-screen” user interfaces for convenience, durability, and pleasing aesthetic properties, such control interfaces have not been successfully adapted for dishwashers and/or other “wet” washing appliances due to the difficulties in providing a substantially fluid-tight control console member about a touch-screen interface that may still allow the touch-screen interface to be easily accessible by the user of the appliance.

Therefore, there exists a need in the art for a control console for a washing appliance (such as a dishwasher) that may house and protect a touch-screen interface such that the touch-screen interface may be easily accessed by the user to enter control inputs to the appliance. There further exists a need for a control console for a washing appliance that is capable of providing a substantially fluid-tight housing for a touch-screen interface, such that the interface may remain robust and operable in an excessively wet environment.

### BRIEF SUMMARY OF THE INVENTION

Certain embodiments of the present invention satisfy the above and other needs and provide other advantages as described below. Embodiments of the present invention may include a touch-screen user interface system for a dishwasher, wherein the system comprises an illuminated display operably engaged with a door of the dishwasher, the illuminated display including a plurality of touch-responsive surfaces disposed thereon. The touch-responsive surfaces may be formed using touch-screen technologies that may include, but are not limited to: resistive touch-screens; surface wave touch-screens; capacitive touch-screens; infrared touch-screens; strain gage touch-screens; optical imaging touch-screens; dispersive signal touch-screens; acoustic pulse recognition touch-screens; and combinations of such touch-responsive surfaces.

The user interface system may further comprise a cover operably engaged with the illuminated display so as to enclose the illuminated display in a substantially fluid-tight arrangement, wherein the cover comprises a lens member defining a plurality of transparent portions and a console member integrally-formed about the lens member. According to such embodiments, the console member may be configured for positioning the lens member relative to the illuminated display such that the plurality of transparent portions of the lens member are positioned substantially adjacent the corresponding plurality of touch-responsive surfaces associated with the illuminated display, and such that each of the plurality of touch-responsive surfaces is visible and accessible to a user of the dishwasher via the lens member. In order to reinforce the mechanical structure of the cover, some embodiments may further comprise a plurality of interlock structures operably engaged between the lens member and the console member.

Various embodiments of the present invention may also provide methods for manufacturing a touch-screen user interface adapted to be operably engaged with a door of a dishwasher. Some exemplary embodiments comprise inserting an in-mold decoration film into a first polymer injection mold, wherein the in-mold decoration film defines a plurality of transparent portions. The method further comprises injecting a first molten polymer into the first polymer injection mold to form a lens member about the in-mold decoration film such that the plurality of transparent portions extend through a thickness of the lens member. In order to integrally form a console member about the lens member, the method may also comprise inserting the lens member into a second polymer injection mold and injecting a second molten polymer into the second polymer injection mold to form a console member about the lens member. The resulting console member may thus be adapted for positioning the plurality of transparent portions of the lens member substantially adjacent a corresponding plurality of touch-responsive surfaces associated with a display operably engaged with the door of the dishwasher such that each of the plurality of touch-responsive surfaces are visible and accessible to a user of the dishwasher via the lens member.

Some method embodiments may also comprise inserting a plurality of interlock structures about a perimeter of the first polymer injection mold, before injecting the first molten polymer, such that at least a portion of each of the plurality of interlock structures extends laterally outward from a perimeter of the lens member. As described herein with respect to various system embodiments of the present invention, the interlock structures may be configured for extending substantially into the console member such that the lens member is operably engaged with the console member via the interlock structures and mechanically reinforces the resulting structure.

Thus, various embodiments of the present invention provide many advantages that may include, but are not limited to: providing a robust and substantially fluid-tight touch-screen user interface system for a dishwasher; providing a manufacturing method for integrally forming a plurality of transparent portions in a lens member of a cover such that a touch-responsive display disposed within the cover is visible and/or accessible to a user of a washing appliance, such as a dishwasher, therethrough; and providing an integrally-formed lens member and console member assembly for a touch-screen user interface that is mechanically robust for use as a structural member in the door of a dishwasher. These and other advantages are provided by various embodiments of the present invention.

### BRIEF DESCRIPTION OF THE SEVERAL VIEWS OF THE DRAWINGS

Having thus described various embodiments of the invention in general terms, reference will now be made to the accompanying drawings, which are not necessarily drawn to scale, and wherein:

FIG. 1 is a non-limiting perspective view of an exemplary touch-screen user interface system for a dishwasher, according to one embodiment of the present invention;

FIG. 2 is a non-limiting perspective view of a lens member defining a plurality of transparent portions adapted to provide user access therethrough to an illuminated touch-screen display for a dishwasher, according to one embodiment of the present invention;

FIG. 3 is a non-limiting top view detail of an exemplary lens member, according to one embodiment of the present invention, including a plurality of interlock structures extending outward from the lens member for engaging a surrounding console member so as to mechanically reinforce a cover for a touch-screen user interface system for a dishwasher; and

FIG. 4 is a non-limiting top view of an exemplary touch-screen user interface system for a dishwasher, according to one embodiment of the present invention.

### DETAILED DESCRIPTION OF VARIOUS EMBODIMENTS OF THE INVENTION

Various embodiments of present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Although the various embodiments of the invention described herein are directed to an apparatus and method for assembling a touch-screen user interface for a dish washing machine, it will be appreciated by one skilled in the art that the invention is not so limited. For example, aspects of the washing appliance and method of the present invention can also be incorporated into other appliances (such as laundry washing machines, for example) that may include touch-screen displays configured for receiving user inputs (such as the selection of wash cycles, for example). In one example, the apparatus and method embodiments of the present invention may be used to construct a laundry washing machine having an integrally-formed lens member and console member that may allow the washing machine to receive control inputs therethrough via a touch-screen display or other illuminated display having a plurality of touch-responsive surfaces disposed thereon.

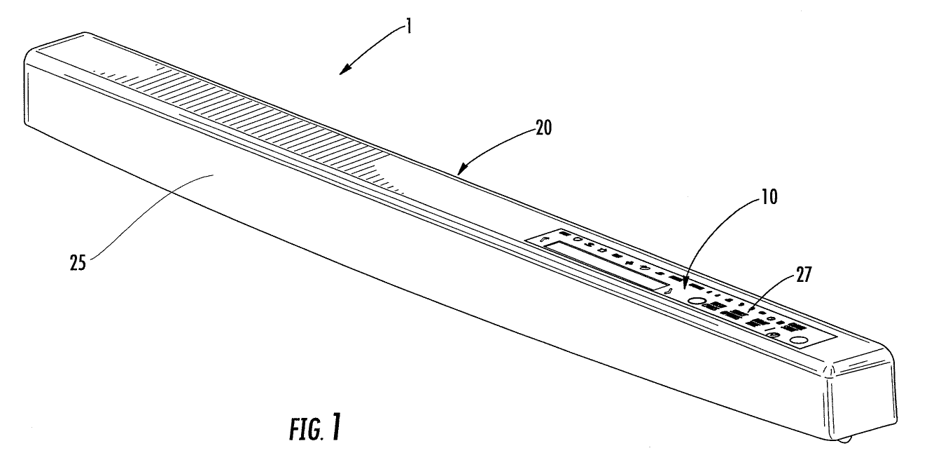

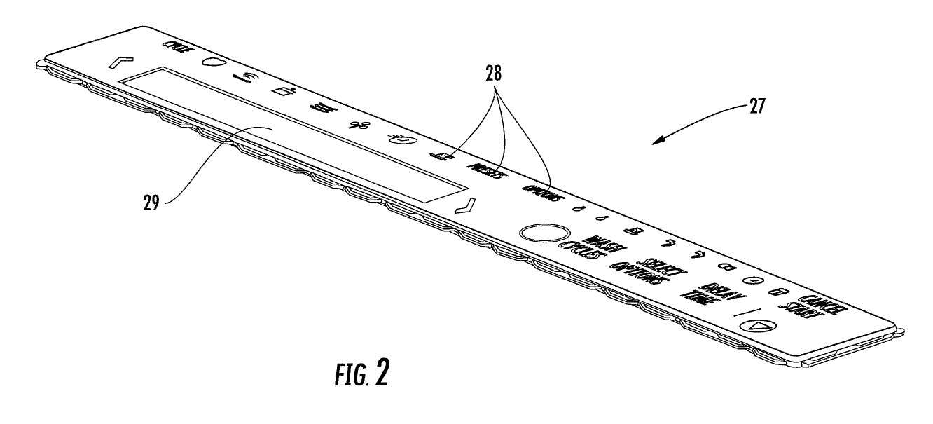

Referring to FIGS. 1 and 2, it should be further understood that various embodiments of the present invention may be configured for use with a variety of touch-screen and/or touch-responsive display technologies such that the “touch-responsive” surfaces recited and described herein may be disposed: (1) on or otherwise associated with an illuminated display 10 disposed within a door endcap or cover 20 (and adjacent to a corresponding plurality of transparent portions 28 of a lens member 27); and/or (2) on, adjacent to, or otherwise associated with one or more of a plurality of transparent portions 28 of a lens member 27 that may be integrally-formed with a console member 25 to form a cover 20 or endcap of a dishwasher door and/or other portion of a washing appliance. Furthermore, various different types of touch-screen and/or touch-responsive display technologies may be used in conjunction with the various lens members 27 and user interface embodiments described herein depending on the location of the touch-responsive surfaces. For example, the touch-screen technologies used in various embodiments of the present invention may include, but are not limited to: resistive touch-screen assemblies; surface wave touch-screen assemblies; capacitive touch-screen assemblies; infrared touch-screen assemblies; strain gage touch-screen assemblies; optical imaging touch-screen assemblies (which may be especially suited to embodiments wherein the active or touch-responsive portions of the user interface are associated with an illuminated display 10 disposed adjacent to (i.e., under) a substantially transparent, but otherwise substantially passive, lens member 27); dispersive signal touch-screen assemblies; acoustic pulse recognition touch-screen assemblies; and combinations of such touch-screen and/or touch-responsive technologies.

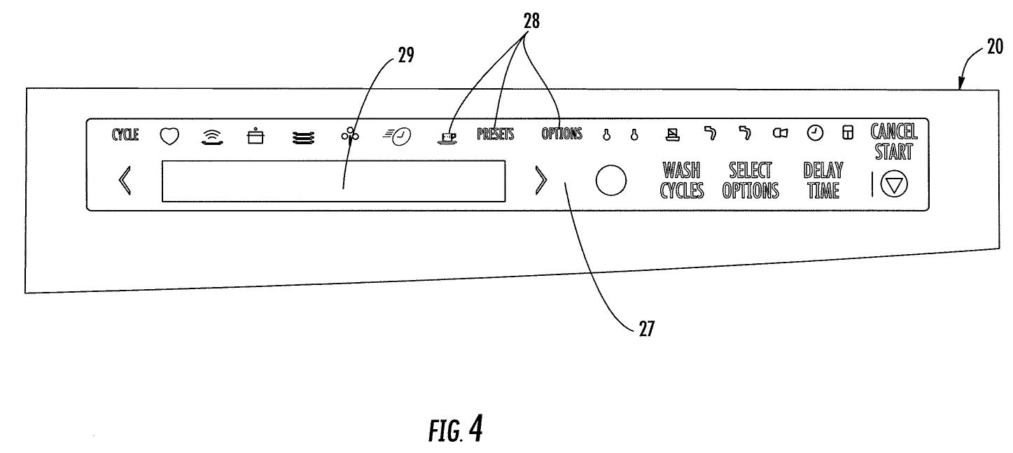

As shown generally in FIG. 1, various embodiments of the present invention provide a touch-screen user interface system 1 for a dishwasher (not shown). FIG. 1 shows an exemplary “end cap” console system 1 adapted to be operably engaged with or about a top portion of the front door of a dishwasher. In one embodiment, the system 1 comprises an illuminated display 10 associated or otherwise operably engaged with a door of the dishwasher wherein the illuminated display 10 includes a plurality of touch-responsive surfaces. Referring again to FIG. 1, the display 10 is disposed generally within the console member 25 of a cover 20, under a lens member 27 of the system 1, such that a plurality of transparent portions 28 (see FIG. 2, for example) of the lens member 27 are disposed generally adjacent to the plurality of touch-responsive surfaces of the illuminated display 10. As such, each of the plurality of touch-responsive surfaces are visible and or otherwise accessible to a user of the dishwasher via the lens member 27 (i.e., though the lens member 27/console system 25 fluidly isolates the touch-responsive surfaces from the moist environment of the dishwasher, the touch-responsive surfaces can be actuated by touching the lens member 27, wherein the touch-responsive surfaces are configured to sense the touch through the lens member 27). FIG. 4 shows an exemplary top view of the lens member 27 of the system 1 including a detailed view of the pictograms and/or other information transparent portions 28 defined in the lens member 27 that may correspond substantially to the plurality of touch-responsive surfaces of the illuminated display 10 that may be disposed within the cover 20 of the system 1.

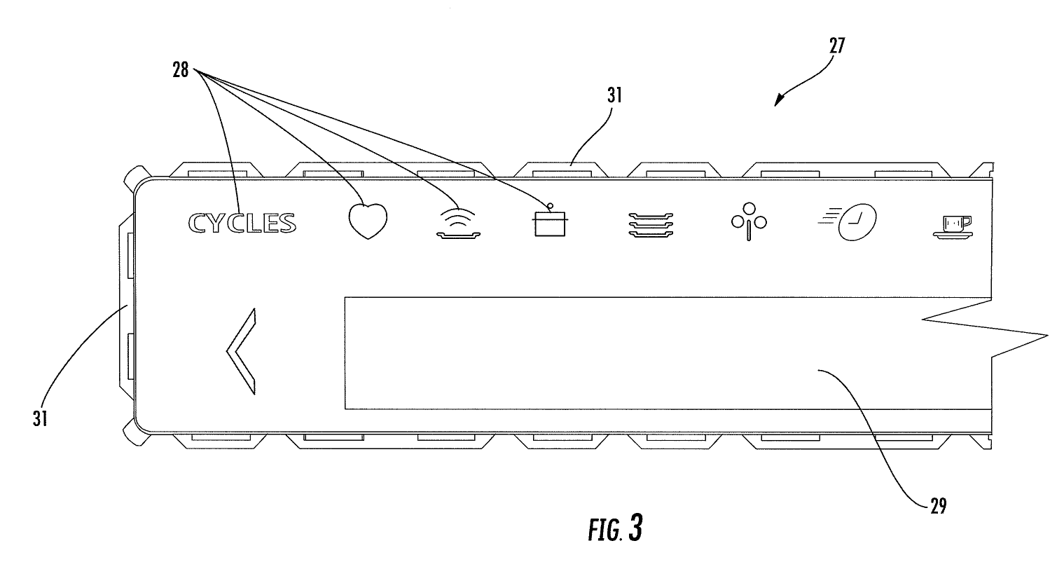

The cover 20 is operably engaged with and/or encloses (see, e.g., the exemplary embodiment of FIG. 1) the illuminated display 10 such that the illuminated display 10 is protected by the substantially fluid-tight configuration of the cover 20. The cover 20 further comprises a lens member 27 defining a plurality of transparent portions 28 (see FIG. 2, for example). As shown in FIG. 3, each of the plurality of transparent portions 28 of the lens member 27 may be formed to include or otherwise represent pictograms, symbols, and/or alphanumeric indicia that may be generally indicative of the functions of the various touch-responsive surfaces associated with the illuminated display 10. In some embodiments, the plurality of transparent portions 28 of the lens member 27 may also comprise a display window 29 configured and/or positioned such that an informational and/or alphanumeric display portion of the illuminated display 10 may be visible to a user of the system 1 via the display window 29. As described further herein with respect to the various manufacturing methods for producing a touch-screen user interface system 1 associated with embodiments of the present invention, the transparent portions 28 of the lens member 27 may be defined, in some embodiments, by inserting an in-mold decoration (IMD) film into an polymer injection mold and subsequently injecting molten polymeric material into that mold to form the lens member 27 about the transparent portions 28 of the film, such that the IMD film determines the locations and/or various shapes or symbols associated with the transparent portions 28 defined in the lens member 27 (see, for example, a resulting lens member 27 in FIG. 3). The lens member 27 and the IMD film used to form the transparent portions 28 thereof may be formed of a variety of polymer materials that may be suited for injection molding and/or other polymer forming processes. In other embodiments, the lens member 27 may comprise a glass and/or Pyrex™ material about which the console member 25 (see FIG. 1) may be overmolded to form the substantially integral and/or fluid-tight cover 20 of the touch-screen user interface system 1.

Referring again to FIG. 1, the cover 20 further comprises a console member 25 integrally-formed about the lens member 27 and configured for positioning the lens member 27 relative to the illuminated display 10 such that the plurality of transparent portions 28 of the lens member 27 are positioned substantially adjacent the corresponding plurality of touch-responsive surfaces associated with the illuminated display 10, and such that each of the plurality of touch-responsive surfaces are visible and accessible to a user of the dishwasher via the lens member 27 (i.e., operable through the lens member 27). As described further herein, the lens member 27 may be substantially integrally-formed (via injection molding and/or an “overmolding” process, for example) with the console member 25 such that the resulting cover 20 of the system 1 provides a unitary structural member (i.e. a dishwasher door end cap, for example) that encloses the illuminated display 10 in a substantially fluid-tight manner. The console member 25 may also comprise a plurality of different polymer materials that are suited for injection molding (and/or overmolding) about a lens member 27. For example, the console member 25 may be formed of a “low-melt” polymer material having a melting point that is substantially lower than the polymer and/or glass material used to form the lens member 27 such that the molten material used to form the console member 25 may be injected into an injection mold without affecting the dimensional and/or structural stability of the lens member 27 (or the transparent portions 28 defined therein).

As shown generally in FIG. 3, a plurality of interlock structures may be operably engaged between the lens member 27 and the console member 25 so as to provide reinforcement when the lens member 27 is coupled with the cover 20 (FIG. 1). As described further herein with respect to the various manufacturing method embodiments of the present invention, the lens member 27 may be provided with a plurality of interlock structures 31 extending outward about a periphery thereof such that, as the console member 25 assembly is overmolded (i.e. injected molded about the lens member 27 and the interlock structures 31 extending outward therefrom), the interlock structures 31 may provide a positive mechanical lock to the console member 25 structure of the cover 20.

Various embodiments of the present invention may also provide methods for manufacturing a touch-screen user interface (such as the touch-screen user interface system 1 described herein) adapted to be operably engaged with a door of a dishwasher or other washing appliance. In one exemplary embodiment, the manufacturing method comprises inserting an in-mold decoration (IMD) film into a first polymer injection mold that may be sized and/or configured to form the lens member 27 assembly (see FIG. 2, for example). As described herein, the IMD film may define a plurality of transparent portions 28 in the lens member 27. The method may also further comprise injecting a first molten polymer (i.e. the polymer used to form the body of the lens member 27 assembly) into the first polymer injection mold to form a lens member 27 about the IMD film such that the plurality of transparent portions 28 extend through a thickness of the lens member 27. FIG. 2 shows a completed lens member 27 assembly produced according to one embodiment of the present invention.

As shown in FIG. 2, the lens member 27 assembly steps may further comprise inserting a plurality of interlock structures 31 about a perimeter of the first polymer injection mold before injecting the first molten polymer such that at least a portion of each of the plurality of interlock structures 31 extend laterally outward from a perimeter of the lens member 27 (see FIGS. 2 and 3, for example). As described herein with respect to the various system 1 embodiments of the present invention the interlock structures 31 may be configured to extend substantially into the console member 25 such that the lens member 27 is operably engaged with the console member 25 via the interlock structures 31 to provide a substantially unitary structure and/or integrally-formed cover 20 having a robust structural capacity (so as to be capable of forming a console and/or end cap disposed on or about a top portion of a dishwasher door, for example).

Various method embodiments of the present invention may further comprise inserting the lens member 27 assembly (see FIGS. 2 and 3, for example) into a second polymer injection mold, and injecting a second molten polymer into the second polymer injection mold to form a console member 25 about the lens member 27 assembly such that the lens member 27 is integrally-formed into the console member 25. As such, a substantially unitary and/or integrally-formed cover 20 for an underlying touch-screen display 10 is formed. Furthermore, as described herein with respect to the various system 1 embodiments of the present invention, the console member 25 may also be adapted for positioning the plurality of transparent portions 28 (as defined, for example, by an IMD film pattern) of the lens member 27 assembly substantially adjacent a corresponding plurality of touch-responsive surfaces of a display 10 associated with the door of the dishwasher such that each of the plurality of touch-responsive surfaces are visible and accessible to a user of the dishwasher or other washing appliance via the lens member 27.

As described further herein, the second molten polymer used to form the console member 25 may, in some embodiments, comprise a “low melt” injectable polymer material having a melting point that is substantially less than a corresponding melting point of the first molten polymer used to form the lens member 27 assembly such that the console member 25 may be “overmolded” with respect to the lens member 27 assembly without detrimentally affecting the structure or dimensional stability of the lens member 27 assembly (or the transparent portions 28 and/or display windows 29 defined therein).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A touch-screen interface for a dishwasher door, said touch-screen interface comprising:
a console member; and
a lens member coupled with said console member so as to restrict passage of fluid therebetween, the lens member being configured to facilitate touch communication therethrough.

2. A touch-screen interface according to claim 1, wherein said console member is at least partially comprised of a polymeric material.

3. A touch-screen interface according to claim 2, wherein said lens member is molded with said console member so as to be integral therewith.

4. A touch-screen interface according to claim 2, wherein said lens member includes at least one interlocking structure disposed about a perimeter thereof, the at least one interlocking structure being configured to be molded into the console assembly, for reinforcing said coupling between said lens member and said console wall.

5. A touch-screen interface according to claim 1, wherein said console member is configured to be coupled to a dishwasher door such that at least one touch sensitive component associated with said dishwasher door is disposed in communication with the lens member so as to be capable of receiving communication therethrough.

6. A touch-screen interface according to claim 5, wherein said lens member is at least partially light transmissive and the at least one touch sensitive component includes a light-emitting element capable of emitting light, such that the light is visually perceptible through the lens member.

7. A touch-screen interface according to claim 1, further comprising at least one touch sensitive component coupled to said console member, wherein said at least one touch sensitive component is configured to receive touch communication through the lens member.

8. A touch-screen interface according to claim 7, wherein said at least one touch sensitive component is disposed proximate to said lens member.

9. A touch-screen interface according to claim 7, wherein said at least one touch sensitive component is integrated with one of said lens member and said console member.

10. A touch-screen interface according to claim 7, wherein said at least one touch sensitive component is selected from the group consisting of a resistive touch-screen, a surface wave touch-screen, a capacitive touch-screen, an infrared touch-screen, a strain gage touch-screen, an optical imaging touch-screen, a dispersive signal touch-screen, and an acoustic pulse recognition touch-screen.

11. A method for forming a touch-screen interface for a dishwasher door, said method comprising:
coupling a console member with a lens member configured to facilitate touch communication therethrough such that the lens member is integral with the console member.

12. A method according to claim 11, wherein coupling a console member with a lens member includes:
inserting the lens member into a console injection mold; and
injecting a molten polymer into the console injection mold to form the console member about the lens member.

13. A method according to claim 11, wherein said coupling a console member with a lens member includes:
providing an in-mold decoration film, the in-mold decoration film defining a plurality of transparent portions; and
coupling a lens member with the in-mold decoration film, the in-mold decoration film defining a plurality of translucent portions, such that the in-mold decoration film is integral with the lens member and the plurality of translucent portions extend through a thickness of the lens member.

14. A method according to claim 13, wherein said coupling a lens member with an in-mold decoration film includes:
inserting the in-mold decoration film into a lens injection mold; and
injecting a molten polymer into the lens injection mold to form the lens member about the in-mold decoration film.

15. A method according to claim 11, further comprising coupling at least one touch sensitive component with the console member such that the at least one touch sensitive component is capable of receiving touch communication through the lens member.

16. A method according to claim 15, wherein said coupling at least one touch sensitive component with the console member includes coupling at least one of a resistive touch-screen, a surface wave touch-screen, a capacitive touch-screen, an infrared touch-screen, a strain gage touch-screen, an optical imaging touch-screen, a dispersive signal touch-screen, or an acoustic pulse recognition touch-screen with the console member.

17. A dishwasher door comprising:
a door structure; and
a touch-screen interface coupled to said door structure, said touch-screen interface comprising:
a console member; and
a lens member coupled with said console member so as to restrict passage of fluid therebetween, the lens member being configured to facilitate touch communication therethrough.

18. A dishwasher door according to claim 17, wherein said console member is at least partially comprised of a polymeric material.

19. A dishwasher door according to claim 18, wherein said lens member is molded with said console member so as to be integral therewith.

20. A dishwasher door according to claim 18, wherein said lens member includes at least one interlocking structure disposed about a perimeter thereof, the at least one interlocking structure being configured to be molded into the console assembly, for reinforcing said coupling between said lens member and said console wall.

21. A dishwasher door according to claim 17, wherein said console member is configured to be coupled to a dishwasher door such that at least one touch sensitive component associated with said dishwasher door is disposed in communication with the lens member so as to be capable of receiving communication therethrough.

22. A dishwasher door according to claim 21, wherein said lens member is at least partially light transmissive and the at least one touch sensitive component includes a light-emitting element capable of emitting light, such that the light is visually perceptible through the lens member.

23. A dishwasher door according to claim 17, further comprising at least one touch sensitive component coupled to said console member, wherein said at least one touch sensitive component is configured to receive touch communication through the lens member.

24. A dishwasher door according to claim 23, wherein said at least one touch sensitive component is disposed proximate to said lens member.

25. A dishwasher door according to claim 23, wherein said at least one touch sensitive component is integrated with one of said lens member and said console member.

26. A dishwasher door according to claim 23, wherein said at least one touch sensitive component is selected from the group consisting of a resistive touch-screen, a surface wave touch-screen, a capacitive touch-screen, an infrared touch-screen, a strain gage touch-screen, an optical imaging touch-screen, a dispersive signal touch-screen, and an acoustic pulse recognition touch-screen.

27. A touch-screen interface for a dishwasher door, said touch-screen interface comprising:
a console member including a console wall; and
a lens member including at least one interlocking structure disposed about a perimeter thereof, said at least one interlocking structure being at least partially disposed within said console wall.

28. A touch-screen interface according to claim 27, wherein said at least one interlocking structure is coupled with said lens member so as to protrude laterally outward therefrom.

29. A touch-screen interface according to claim 27, wherein the at least one interlocking structure is configured to cooperate with the lens member to define an aperture.

30. A touch-screen interface according to claim 29, wherein said console wall is configured to extend through the aperture so as to surround said at least one interlocking structure, thereby mechanically interlocking said lens member and said console member.

31. A touch-screen interface according to claim 27, further comprising at least one touch sensitive component coupled to said console member, wherein said at least one touch sensitive component is configured to be capable of receiving touch communication through the lens member.

32. A touch-screen interface according to claim 31, wherein said at least one touch sensitive component is selected from the group consisting of a resistive touch-screen, a surface wave touch-screen, a capacitive touch-screen, an infrared touch-screen, a strain gage touch-screen, an optical imaging touch-screen, a dispersive signal touch-screen, and an acoustic pulse recognition touch-screen.

33. A method for forming a touch-screen interface for a dishwasher door, said method comprising:
coupling a console wall of a console member with a lens member, the lens member including at least one interlocking structure disposed about a perimeter thereof, such that the at least one interlocking structure is at least partially disposed within the console wall.

34. A method according to claim 33, wherein said coupling a console wall of a console member with a lens member includes:
inserting the lens member into a console injection mold; and
injecting a molten polymer into the console injection mold to form the console member about the at least one interlocking structure of the lens member, and such that the lens member is integral with the console member.

35. A method according to claim 33, further comprising:
coupling the lens member with an in-mold decoration film, the in-mold decoration film defining a plurality of translucent portions, such that the in-mold decoration film is integral with the lens member and the plurality of translucent portions extend through a thickness of the lens member.

36. A method according to claim 35, wherein coupling the lens member with the in-mold decoration film includes:
inserting an in-mold decoration film into a lens injection mold; and
injecting a molten polymer into the lens injection mold to form the lens member about the in-mold decoration film.

37. A method according to claim 36, further comprising inserting at least one interlocking structure into the lens injection mold such that the at least one interlocking structure protrudes laterally outward from the lens member formed by injecting the molten polymer into the lens injection mold.

38. A method according to claim 37, wherein said inserting at least one interlocking structure further comprises inserting at least one interlocking structure into the lens injection mold such that said lens member formed by injecting the molten polymer into the lens injection mold cooperates with the at least one interlocking structure to define an aperture.

39. A method according to claim 38, wherein injecting a molten polymer into the console injection mold further comprises injecting the molten polymer into the console injection mold such that the console wall extends through the aperture to surround said interlocking structure, thereby mechanically interlocking said lens member and said console member.

40. A method according to claim 33, further comprising coupling at least one touch sensitive component with the console member such that the at least one touch sensitive component is capable of receiving touch communication through the lens member.

41. A method according to claim 40, wherein said coupling at least one touch sensitive component with the console member includes coupling at least one of a resistive touch-screen, a surface wave touch-screen, a capacitive touch-screen, an infrared touch-screen, a strain gage touch-screen, an optical imaging touch-screen, a dispersive signal touch-screen, or an acoustic pulse recognition touch-screen with the console member.

42. A dishwasher door comprising:
a door structure; and
a touch-screen interface coupled to said door structure, said touch-screen interface comprising:
a console member including a console wall; and
a lens member including at least one interlocking structure disposed about a perimeter thereof, said lens member being coupled to the console wall such that said at least one interlocking structure is at least partially disposed within said console wall.

43. A dishwasher door according to claim 42, wherein said at least one interlocking structure is coupled with said lens member so as to protrude laterally outward therefrom.

44. A dishwasher door according to claim 43, wherein the at least one interlocking structure is configured to cooperate with the lens member to define an aperture.

45. A dishwasher door according to claim 44, wherein said console wall is configured to extend through the aperture so as to surround said at least one interlocking structure, thereby mechanically interlocking said lens member and said console member.

46. A dishwasher door according to claim 42, further comprising at least one touch sensitive component coupled to said console member, wherein said at least one touch sensitive component is configured to be capable of receiving touch communication through the lens member.

47. A dishwasher door according to claim 46, wherein said at least one touch sensitive component is selected from the group consisting of a resistive touch-screen, a surface wave touch-screen, a capacitive touch-screen, an infrared touch-screen, a strain gage touch-screen, an optical imaging touch-screen, a dispersive signal touch-screen, and an acoustic pulse recognition touch-screen.
